(19) United States
(12) Patent Application Publication
(10) Pub. No.: US 2013/0186902 A1
(43) Pub. Date: Jul. 25, 2013

(54) MULTI-PURPOSE DEVICE FOR MOBILE PAINT TRAYS, TUBS AND CONTAINERS

(71) Applicant: Hanan BAR-SHLOMO, Ramat Hasharon (IL)

(72) Inventor: Hanan BAR-SHLOMO, Ramat Hasharon (IL)

(21) Appl. No.: 13/733,898

(22) Filed: Jan. 4, 2013

(30) Foreign Application Priority Data
Jan. 12, 2012 (IL) 217487

(51) Int. Cl. B05C 21/00

(52) U.S. Cl. CPC B05C 21/00
USPC 220/570

(57) ABSTRACT

The product is the invention of a device-application on wheels that is connected to a standard paint tray, tubs and containers. When the device is connected to the paint tray it is possible to mobilize a paint tray on wheels. The devices with the wheels are connected to the upper ledge of the tray or tubs or containers. The devices make it possible for the paint tray to be mobile or stationary. When in a stationary position, the tray stops by the lower frontal part of the tray itself, and the backside of the tray stays standing on wheels and this causes a halt and an inability to move. When in a mobile position, by pressing the holder of the roller or on the deep backside of the tray by the roller, the frontal part of the tray rises and transfers its weight to all the wheels and thus allows a mobile position. The moveable tray is permissible because the connection of the device to the backside ledge is low in comparison to the other devices. The former lower backside device can be activated with a spring or without a spring.

### TECHNICAL FIELD

The product in concern is the invention of a device(s)-application to enable mobile paint trays or tubs or containers.

### BACKGROUND OF THE INVENTION

Professional people in the field of paint, and amateurs usually paint walls or ceilings or other things with the use of a brush or a roller for painting. Many manufacturers produce tools to aid in the activity of painting and paint trays. It is usually accepted to dip the roller/or paintbrush in the paint tray and to paint. The accepted usage of the standard paint tray has several limitations: Firstly, moving the paint tray from one point to another point, according to the advancement of the painting is very clumsy. Usually, the user has to bend down, hold the tray in his hand, and move it from one point to the next. Sometimes, the user moves the paint tray by pushing it with his leg or with the use of his roller. This causes scratches on the floor. Secondly, dirt and splashes of paint on the floor. Thirdly, during painting, paint drips on the panels, this needs immediate cleaning. This delays the fluency and rhythm of paint work. Fourthly, during painting with the standard paint tray, this causes exceptional tiring physical effort, backache, because one has to move it from place to place when one colors.

### SUMMARY OF THE INVENTION

The following invention is a device(s)-application with wheels for paint trays or tubs or containers, that give a solution to the above problems, and makes the painting work more efficient.

Other features and advantages of the instant invention will become apparent from the following description of the invention which refers to the accompanying drawings.

### BRIEF DESCRIPTION OF THE DRAWINGS

FIG. 1 is a side view of an embodiment of the present invention.

FIG. 2 is a perspective view of the present invention installed on a paint tray.

FIG. 3 is a side view of the invention shown in FIG. 2.

### DETAILED DESCRIPTION OF THE INVENTION

The following drawings do not try and limit the scope of the invention and its implementation. The drawings intend to demonstrate the invention and a possibility of one way from many others.

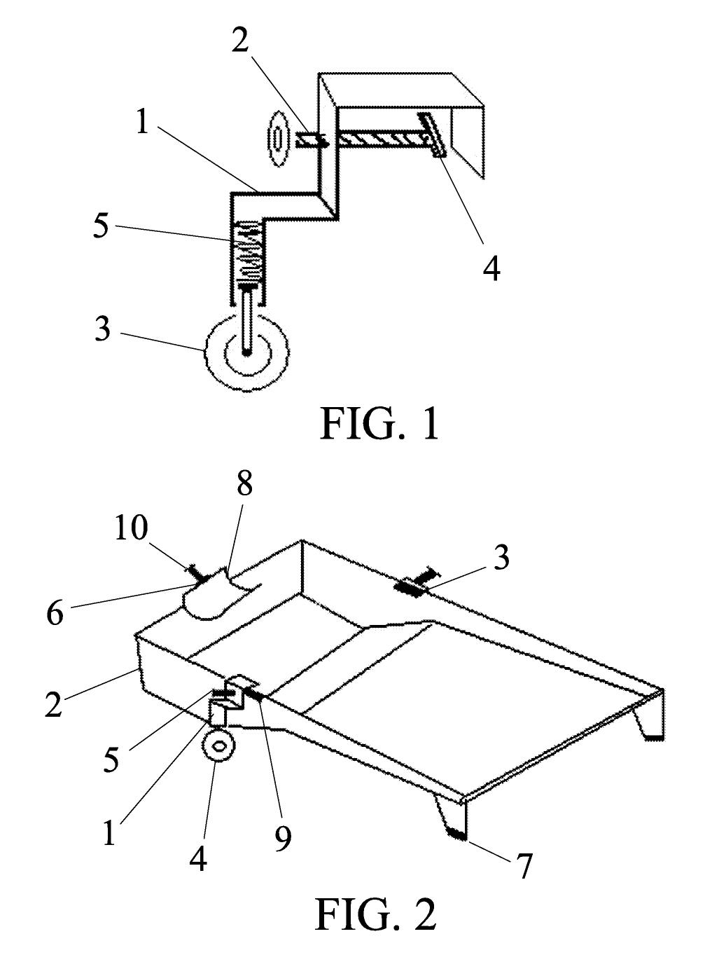

In FIG. 1, the device illustrates from the side (1) that the upper part has a catch (2) underneath the wheels (3) The tip of the catch has a holder (4) that causes stability and a strong stable connection for the device to the paint tray. The lower part of the device there is a spring (5) on the hinge of the wheel.

In FIG. 2 the device illustrates the upper view of the device (1) that is connected to the standard paint tray (2) The devices are connected to several points (3) to the edge of the paint tray. To the lower part of the device is connected a wheel (4). Every device has a catcher on the upper part (5) to connect to the paint tray. One device or more, will be connected to the deep backside of the paint tray (6) The lower part the frontal part of the paint tray results in a halting of the tray with or without rubbers (7) On the upper edge of the deep back part is attached a stand on the device itself (8). This is intended to press with the roller in order to lift the frontal part and enable mobility of the paint tray. The upper part of the device has a catcher (9) that causes the stability and a strong stable connection of the device to the paint tray. The mobility of the tray is enabled because the back connection of the device is lower (10) in comparison to other devices. The device with the backside connection can be activated with or without a spring when mobile thus it can be activated also at an equal height to the other devices.

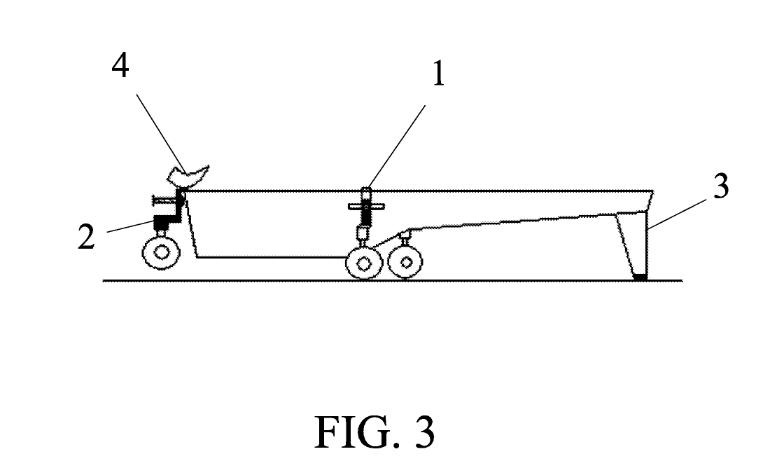

FIG. 3 illustrates the invention of the device from the side view that includes an example of connections of the devices (1) to the standard paint tray. And a backside device with the option to lowering (2) compared to the other devices in order to enable lifting of the frontal part (3) of the paint tray and transfer the weight to the backside to move the tray. On the edge of the paint tray that is on the deep backside is attached a stand on the device itself or on the paint tray (4). This is intended for pressing with the roller, in order to lift the frontal part and allow mobility of the paint tray.

What is claimed is:

1. A device for an application for paint trays, tubs and containers that its lower part has one wheel or two and is transformed conditionally according to the weight in the container.

2. The device as in claim number 1 includes a catcher with or without screwing.

3. The device as in claim number 2 includes a wheel.

4. The device as in claim number 3 includes a spring in the body of the device.

5. The device as in claim number 3 includes one or more devices from all the other devices lowerer in comparison to the others.

6. The device as in claim number 5 includes a base for the roller that is fixed on the edge of the tray or on the body of the device.

7. The device as in claim number 6 is used for as a comfortable base for the roller when halting when painting.

8. The device as in claim number 7 is used for to press on the device without having to dip the roller in the paint, and thus one is able to move it from place to place.

9. The device as in claim number 7 includes a connection between the device to the base of the roller.
